(19) United States
(12) Patent Application Publication
(10) Pub. No.: US 2006/0156974 A1
(43) Pub. Date: Jul. 20, 2006

(54) Device for applying glue onto book blocks

(76) Inventors: Holger Muller-Lorenschat, Rahden (DE); Klaus Waring, Stemwede-Oppendorf (DE)

Correspondence Address: ALIX YALE & RISTAS LLP, 750 MAIN STREET, SUITE 1400, HARTFORD, CT, 06103, US

(21) Appl. No.: 11/323,206

(22) Filed: Dec. 30, 2005

(30) Foreign Application Priority Data
Jan. 20, 2005 (DE) DE 102005002737.7

(51) Int. Cl. B05C 1/08

(52) U.S. Cl. 118/261; 118/200; 118/258

(57) ABSTRACT

Apparatus for applying glue (4) onto book block spines, including a glue basin (5), at least one application roller (6) that is partially immersed in the glue basin (5) and the periphery of which rolls over the book blocks (2). In order to apply the glue exactly and with a uniform thickness when operating at high cycle capacities, the length and the thickness of the glue application are controlled with two separate roller scrapers. A first (metering) scraper (7) can be adjusted relative to the application roller (6) for metering the thickness of the glue being applied, and a second (on/off) scraper (8) can be adjusted between an application position and a zero application position. The distance of the on/off scraper (8) from the application roller (6) is greater than that of the metering roller (7) in the application position. The on/off scraper (8) has a fixed stroke such that simple actuators can be used for generating this digital control movement, e.g., a solenoid or a pneumatic cylinder or a simple cam mechanism (10, 11, 12a, b).

### BACKGROUND OF THE INVENTION

The present invention pertains to a device for applying glue onto book blocks or the like, particularly for applying glue onto book block spines.

Glue applicators of the aforementioned type are also referred to as roller-type gluing stations. Such a gluing station is schematically illustrated on pages 284 ff. of the reference book “Industrielle Buchbinderei” by Dieter Liebau and Ines Heinze, 2nd Edition, 2001, Verlag Beruf+Schule, Itzehoe. This gluing station comprises two application rollers that are arranged in succession and partially immersed in a glue basin. The application rollers rotate synchronously in the block transport direction and thusly apply the glue onto the spines of the book blocks. The thickness of the glue application can be varied with the aid of respective scrapers that are assigned to each application roller and adjustable relative to the roller surface. The length of the glue application can also be varied by adjusting the respective scraper between a zero application position in which it acts as a scraper and the desired application position.

In known roller-type gluing stations, the scrapers are controlled with the aid of control curves. In order to prevent excessive wear, the cam roller of the respective control lever is in constant contact with the control curve, wherein a spring element is arranged between the control lever and the scraper in order to limit the stroke of the scraper defined by the control curve with the aid of adjustable limit stops and thusly realize adjustable application positions. Steeper curve flanks are required when the glue is applied with uniform thickness from the beginning to the end. This leads to vibrations in the scraper control mechanism, particularly at high cycle capacities, where the vibrations are superimposed on the movement of the scraper and thusly lead to an uneven application of the glue. The beginning and the end of the glue applied onto the book block consequently are shifted independently of the cycle capacity or the glue is not applied with the desired thickness.

DE 197 14 598 A1 pertains to a glue applicator for backlining strips with narrow lateral scrapers that can be adjusted separately of a primary scraper and are arranged upstream thereof, directly in front of the primary scraper of adjustable application thickness. The lateral scrapers apply the glue onto the application roller with a smaller thickness than the primary scraper such that different thicknesses of glue can be realized on the application roller under the ensuing effect of the primary scraper. A defined glue application length can be realized by controlling the primary scraper accordingly.

### SUMMARY OF THE INVENTION

The present invention is based on the objective of making available a device for applying glue onto book blocks or the like, particularly for applying glue onto book block spines, whereby it is possible to exactly apply the glue with a uniform thickness with a simple and cost-efficient design.

This is achieved by controlling the thickness and the length of the glue application by two separate scrapers, wherein an adjusting device is provided for the first (metering) scraper and a separate control device is provided for the second (on/off) scraper. Since the distance of the on/off scraper from the application roller is greater than that of the metering scraper in the application position, the thickness of the glue application is defined by the metering scraper only. A spring element is not required in the control device for the on/off scraper; therefore the scraper is much more rigid and substantially fewer vibrations are superimposed on its movement.

With respect to a simple construction, it is advantageous that the on/off scraper has a fixed stroke. This digital control movement can be realized with the aid of simple actuators such as solenoids, pneumatic cylinders or the like. It would also be conceivable to utilize a simple cam mechanism, in which the stroke of the on/of scraper is defined by the control curve and the cam roller remains in constant contact with the curve. This stroke is preferably about twice as large or larger than the maximum adjustable distance of the metering scraper. Conventional motive functions on the control curve make it possible to realize very fast switching times for switching the glue application on and off, because the glue is already applied or scraped off by/to the thickness defined by the metering scraper once the first half of the motive function and therefore the scraper stroke is completed.

The metering scraper is advantageously arranged upstream, with the on/of scraper preferably being arranged downstream of the metering scraper. According to one preferred embodiment of the invention, the effective scraper edges of both scrapers are spaced apart from one another by distance of only a few millimeters such that the glue thickness defined by the metering scraper is applied on the application roller immediately after the on/off scraper is opened. In addition, it is ensured that the glue scraped off by means of the on/off scraper flows back from the application roller into the glue basin without forming any incrustations. In this respect, it is also advantageous to create a larger free space between the scrapers on the other side of the scraper edges, wherein the scraper arranged upstream is preferably realized shorter referred to the radial direction of the application roller.

### BRIEF DESCRIPTION OF THE DRAWING

One embodiment of the device according to the invention is described below with reference to the figures, wherein:

FIG. 1 is a detail of a section through a roller-type gluing station in the glue application position;

FIG. 2 is the roller-type gluing station according to FIG. 1 in the zero application position; and

FIG. 3 is a perspective representation of an application roller with a metering scraper and an on/off scraper.

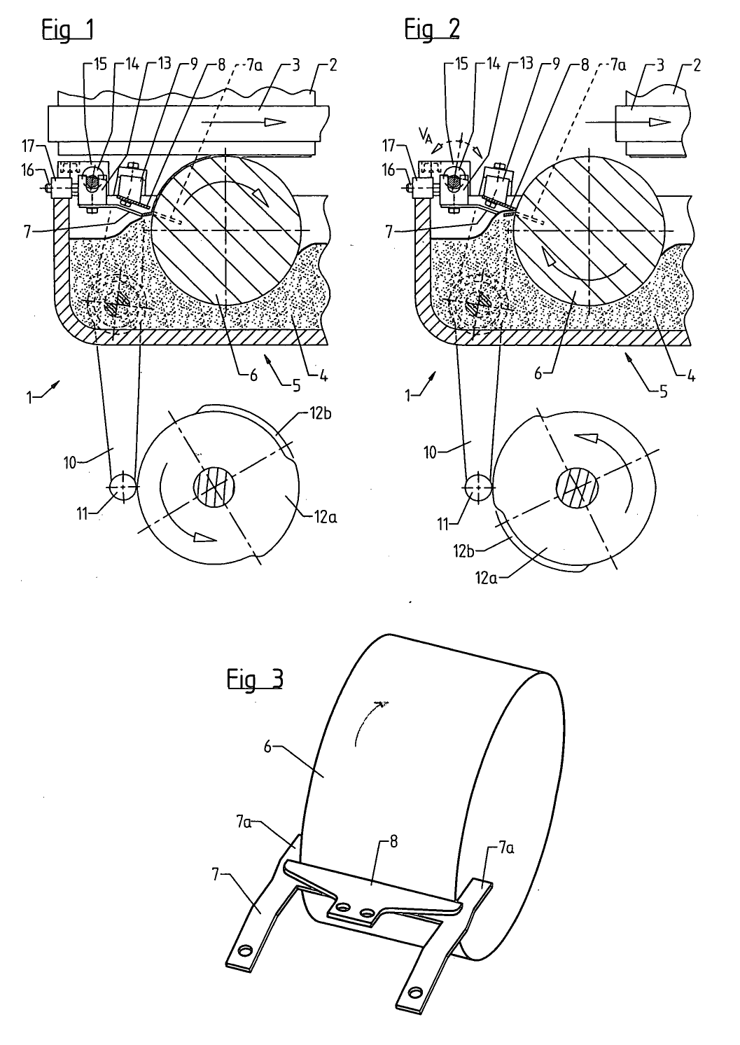

### DESCRIPTION OF THE PREFERRED EMBODIMENT

The roller-type gluing station 1 for applying glue 4 onto the spine of a book block 2 is situated underneath a transport device, in which the book blocks 2 are continuously transported over the roller-type gluing station 1 in the direction indicated by the arrow while being clamped in block clamps 3, such that their spines point downward and the respective book blocks are uniformly spaced apart from one another. The roller-type gluing station 1 essentially consists of a glue basin 5 for storing a supply of glue 4 and an application roller 6 that synchronously rotates in the block transport direction and is partially immersed in the glue basin 5. The glue 4 picked up by the application roller is transferred onto the spine of the book blocks 2 when the application roller rolls over the respective spines.

According to the invention, the roller-type gluing station 1 comprises two separate scrapers 7, 8, namely a first scraper or metering scraper 7 that can be adjusted relative to the application roller 6 and serves for metering the thickness of the glue application, as well as a second controllable scraper or on/off scraper 8 for realizing a defined length of the glue application. The metering scraper 7 is arranged upstream of the on/off scraper 8. It is mounted in brackets 13 that are linearly guided in guide blocks 17 with the aid of guide shafts 16. The position of the metering scraper 7 and therefore a defined application thickness can be adjusted with the aid of a cam shaft 17 that engages into grooves of the brackets 13 and is supported in bearing blocks 15. The adjustment VA of the application thickness is realized by turning the cam shaft 14 as symbolically indicated in FIG. 2 by the double arrow drawn with broken lines. Lateral scrapers 7a are provided on the ends of the metering scraper 7 in order to scrape the glue 4 off the end faces of the application roller 6.

The on/off scraper 8 is controlled by means of a cam mechanism, in which a pivoted control lever 10 carries out corresponding movements due to the contact of its assigned cam roller 11 with a control curve 12a, b. The on/off scraper 8 is situated on the other end of the cam lever 10 and realized in the form of a double lever. The on/off scraper is mounted on a boom of the control lever 10 by means of a block 9. The movement of the control lever 10 causes the on/off scraper 8 to be cyclically adjusted between an application position and a zero application position. The control curve consists of two adjacent control curves 12a, b in order to realize different glue application lengths, wherein the application length is varied by turning the two control curves relative to one another. This relative rotation can be realized manually while the device is at a standstill or by means of an overriding gear while the device is in operation.

The stroke of the on/off scraper 8 is chosen such that its distance from the application position is preferably approximately equal to at least about twice the distance of the metering scraper 7. This means that the thickness of the glue being applied in the application position is defined by the metering scraper 7 only. As described above, the increased distance results in fast switching times for switching the glue application on and off. Alternatively to a cam mechanism, it would also be possible to utilize simple drive elements that generate a digital control movement for controlling the on/off scraper 8, e.g., solenoids, pneumatic cylinders and the like.

The effective scraper edges of both scrapers 7, 8 are spaced apart from one another by a distance of only a few millimeters (e.g., 3-5 millimeters). Immediately after the on/off scraper 8 is opened, the glue is applied onto the application roller 6 with the thickness defined by the metering scraper 7. In the zero application position, this distance makes it possible for the glue 4 being scraped off by the on/off scraper 8 to flow from the application roller 6 back into the glue basin 5 via the radially narrow metering scraper 7, without forming any incrustations. On the other side of the scraper edges, this is promoted due to the increasing distance between the scrapers 7, 8.

1. Apparatus for applying glue onto book block spines, comprising:
a glue basin;
at least one application roller that is partially immersed in the glue basin and which has a periphery that rolls over the book blocks;
a first, metering scraper at the periphery of the application roller that can be adjusted within a range of application positions relative to said periphery for metering the thickness of the glue being applied onto the application roller; and
a second, controllable (on/off) scraper at the periphery of the application roller that can be adjusted between a zero position for scraping said periphery and an application position retracted from said periphery, and thereby define a length of the glue application;
wherein the distance of the on/off scraper from the application roller in its application position is greater than that of the metering scraper in its application position.

2. The apparatus according to claim 1, wherein the on/off scraper has a fixed distance from the periphery of the application roller in its application position such that the on/off scraper can be controlled with a constant stroke.

3. The apparatus according to claim 1, wherein
the on/off scraper has a stroke that is controlled by a cam mechanism having a control curve; and
said stroke is at least about twice as large as the distance of the metering scraper from the application roller.

4. The apparatus according to claim 1, wherein the metering scraper is arranged upstream of the on/off scraper.

5. The apparatus according claim 1, wherein the scraping edge of the metering scraper is spaced apart from the scraping edge of the on/off scraper by a distance of a few millimeters.

6. The apparatus according to claim 1, wherein the metering scraper and the on/off scraper have trailing edges and a free space is created between the scrapers at the trailing edges.

7. The apparatus according to claim 1, wherein the upstream one of the two scraper is shorter in the radial direction of the application roller than the downstream scraper.

8. The apparatus according to claim 1, wherein one scraper is provided with lateral scrapers extending transversely to said scraper edge, for scraping the glue off the end faces of the application roller.

9. The apparatus according to claim 8, wherein the lateral scrapers are arranged on the metering scraper.

10. The apparatus according to claim 1, wherein the adjusting device for the metering scraper comprises a cam mechanism.

11. The apparatus according to claim 2, wherein,
the on/off scraper has a stroke that is controlled by a cam mechanism having a control curve; and
said stroke is at least about twice as large as the distance of the metering scraper from the application roller.

12. The apparatus according to claim 11, wherein the metering scraper is arranged upstream of the on/off scraper.

13. The apparatus according to claim 12, wherein the metering scraper is shorter in the radial direction of the application roller than the on/off scraper.

14. The apparatus according to claim 13, wherein the metering scraper is provided with lateral scrapers extending transversely to said scraper edge, for scraping the glue off the end faces of the application roller.

15. The apparatus according to claim 11, wherein one scraper is provided with lateral scrapers extending transversely to said scraper edge, for scraping the glue off the end faces of the application roller.
